(19) United States
(12) Patent Application Publication
(10) Pub. No.: US 2011/0129677 A1
(43) Pub. Date: Jun. 2, 2011

(54) ORGANIC-INORGANIC COMPOSITE AND MANUFACTURING METHOD THEREFOR

(75) Inventors: Takahiro Fukuoka, Osaka (JP); Seiji Izutani, Osaka (JP); Hisae Uchiyama, Osaka (JP); Saori Fukuzaki, Osaka (JP); Tadafumi Adschiri, Miyagi (JP)

(73) Assignee: Nitto Denko Corporation, Osaka (JP)

(21) Appl. No.: 12/737,643

(22) PCT Filed: Oct. 29, 2009
(86) PCT No.: PCT/JP2009/005749

§ 371 Date: Feb. 2, 2011

(30) Foreign Application Priority Data
Oct. 30, 2008 (JP) 2008-280200

(51) Int. Cl. B32B 27/38; C08L 63/00; B32B 27/00

(52) U.S. Cl. 428/413; 523/400; 428/688

(57) ABSTRACT

A first resin, a curable precursor of a second resin that differs from the first resin, an inorganic material and a solvent are blended and a mixed solution is prepared. Next, by heating the mixed solution, the solvent is removed and the curable precursor is cured, and an organic-inorganic composite is obtained that comprises a composite resin having a co-continuous phase-separated structure formed from a three-dimensionally continuous first phase made of the first resin and a three-dimensionally continuous second phase made of the second resin, and an inorganic material that is localized at the interface between the first phase and the second phase.

### CROSS-REFERENCE TO RELATED APPLICATIONS

The present application is a 35 USC 371 national stage entry of PCT/JP2009/005749, filed Oct. 29, 2009, which claims priority from Japanese Patent Application No. 2008-280200 filed on Oct. 30, 2008, the contents of all of which are hereby incorporated by reference in their entirety.

### TECHNICAL FIELD

The present invention relates to an organic-inorganic composite and a method for manufacturing the same, and more specifically to an organic-inorganic composite suitably used as a heat-dissipating material or a conductive material, and a method for manufacturing the same.

### BACKGROUND ART

Hybrid devices, high-intensity LED devices, and electromagnetic-induction-heating devices are designed to convert high current into power, light, and heat. Along with miniaturization of these devices, a high current flows into a narrow area, thereby increasing heat generation per unit volume. Therefore, the above-mentioned devices demand heat-dissipating materials or conductive materials having high heat resistance, dielectric strength, insulation, thermal conductivity (heat dissipation) or conductivity.

As the heat-dissipating materials, for example, an organic-inorganic composite material in which a filler having good thermal conductivity such as alumina, silica, silicon nitride, boron nitride, aluminum nitride, and metal particles is mixed in a resin material is known for power electronics.

There has been proposed, for example, that a sealing agent is prepared by filling an epoxy resin composition with inorganic powders containing spherical alumina powders and spherical silica powders having finer particles and higher average sphericity than the spherical alumina powders (see, for example, the following Patent Document 1). With this sealing agent, since small particles are filled between large particles, a filling factor is improved, thereby achieving improvement in thermal conductivity.

As the conductive materials described above, for example, organic-inorganic composite materials in which carbon materials having good conductivity such as carbon black and graphite are mixed in resin materials are known.

### CITATION LIST

### Patent Document

Patent Document 1: Japanese Unexamined Patent Publication No. 2003-306594

### DISCLOSURE OF THE INVENTION

### Problems to be Solved

However, in the above-mentioned heat-dissipating materials or the above-mentioned conductive materials, a filler or a carbon material is simply mixed in a resin material, so that in order to improve heat dissipation and conductivity, it is necessary to increase the mixing proportion of the filler or the carbon material. However, the increase of the mixing proportion leads to increased cost and deterioration in mechanical strength.

In addition, regardless of the increase in the mixing proportion of the filler or the carbon material, there is a limit to improve heat resistance, dielectric strength, insulation, thermal conductivity (heat dissipation) or conductivity.

It is an object of the present invention to provide an organic-inorganic composite capable of ensuring excellent heat dissipation and conductivity even if the proportion of an inorganic material is small relative to the proportion of a compound resin, and a method for manufacturing the organic-inorganic composite.

### Means for Solving the Problem

To solve the above object, the organic-inorganic composite of the present invention contains a composite resin having a co-continuous phase-separated structure formed of a three-dimensionally continuous first phase made of a first resin and a three-dimensionally continuous second phase made of a second resin which is different from the first resin; and an inorganic material localized at an interface between the first phase and the second phase.

In the organic-inorganic composite of the present invention, it is preferable that a surface of the inorganic material is chemically modified.

In the organic-inorganic composite of the present invention, it is preferable that the first resin is a thermoplastic resin, and the second resin is a thermosetting resin.

In the organic-inorganic composite of the present invention, it is preferable that the thermoplastic resin is a polyimide resin or an acrylic resin, and the thermosetting resin is an epoxy resin.

The method for manufacturing the organic-inorganic composite of the present invention includes the steps of blending a first resin, a curable precursor of a second resin which is different from the first resin, an inorganic material, and a solvent to prepare a mixed solution; and removing the solvent by heating the mixed solution and curing the curable precursor, to obtain an organic-inorganic composite containing a composite resin having a co-continuous phase-separated structure formed of a three-dimensionally continuous first phase made of the first resin and a three-dimensionally continuous second phase made of the second resin, and the inorganic material localized at an interface between the first phase and the second phase.

In the method for manufacturing the organic-inorganic composite of the present invention, it is preferable that the first resin is a thermoplastic resin, the second resin is a thermosetting resin incompatible with the thermoplastic resin, and the inorganic material is incompatible with the thermoplastic resin and the thermosetting resin, in which the step of obtaining the organic-inorganic composite includes the steps of removing the solvent by heating the mixed solution to a temperature at which the thermoplastic resin softens or higher and to a temperature lower than a temperature at which the curable precursor is cured, so that a composite precursor in which the thermoplastic resin and the curable precursor are compatible with each other and the inorganic material is dispersed therein is prepared; and crosslinking the curable precursor in the three-dimensionally continuous first phase of the thermoplastic resin by heating the composite precursor to a temperature at which the curable precursor is cured or higher, to form a three-dimensionally continuous second phase of the thermosetting resin, and at the same time, localizing the inorganic material at an interface between the thermoplastic resin and the thermosetting resin.

In the method for manufacturing the organic-inorganic composite of the present invention, it is preferable that a surfactant is further blended in the step of preparing the mixed solution.

### EFFECT OF THE INVENTION

In the organic-inorganic composite of the present invention and the method for manufacturing the same, since the inorganic material is localized at the interface between the three-dimensionally continuous first phase and the three-dimensionally continuous second phase in the first phase, a three-dimensionally continuous inorganic material path is formed. Therefore, such path allows heat or electricity to pass through, thereby achieving effective heat dissipation or electric conduction. In addition, since the inorganic material is localized at the interface between the three-dimensionally continuous first phase and the three-dimensionally continuous second phase, even a small proportion of the inorganic material relative to the composite resin allows heat dissipation or conductivity of the inorganic material to be effectively exhibited.

As a result, the organic-inorganic composite of the present invention obtained by the method for manufacturing the same can be suitably used as a heat-dissipating material or a conductive material while preventing increase in cost or deterioration in mechanical strength.

### EMBODIMENT OF THE INVENTION

In the present invention, the organic-inorganic composite contains a composite resin and an inorganic material. Specifically, it contains a composite resin having a co-continuous phase-separated structure (two-phase structure) formed of a first phase and a second phase, and an inorganic material localized at an interface between the first phase and the second phase.

The first phase is formed three-dimensionally continuous in the composite resin. As a resin (a first resin) which forms the first phase, for example, a thermoplastic resin is used.

Examples of the thermoplastic resin include polyethylene resin, polypropylene resin, acrylic resin, polyvinyl acetate resin, ethylene-propylene copolymer, ethylene-vinylacetate copolymer, polyvinyl chloride resin, polystyrene resin, polyacrylonitrile resin, polyamide resin, polyimide resin, polycarbonate resin, polyacetal resin, polyethylene terephthalate resin, polyphenylene oxide resin, polyphenylene sulfide resin, polysulfone resin, polyether sulfone resin, polyether ether ketone resin, polyallyl sulfone resin, thermoplastic urethane resin, polymethylpentene resin, fluorinated resin, liquid crystal polymer, olefin-vinyl alcohol copolymer, ionomer resin, polyarylate resin, acrylonitrile-ethylene-styrene copolymer, acrylonitrile-butadiene-styrene copolymer, and acrylonitrile-stylene copolymer. Of these, polyimide resin and acrylic resin are preferable.

Examples of the polyimide resin include thermoplastic polyimide, polyetherimide resin, polyamide imide resin, polyester imide resin, polyamino bismaleimide resin, and bismaleimide triazine resin. Of these, polyetherimide resin is preferable.

Examples of the acrylic resin include polymethyl methacrylate resin.

These thermoplastic resins can be used alone or in combination of two or more kinds.

These thermoplastic resins have a glass transition temperature (measurement: DMA (dynamic mechanical analysis)) of, for example, −130 to 300° C., or preferably 50 to 250° C., and a softening temperature (measurement: TMA (thermomechanical analysis)) of, for example, −100 to 400° C., or preferably 80 to 350° C.

The second phase is made of a resin (a second resin) which is different from the first resin, and is formed three-dimensionally continuous in the composite resin. That is, the composite resin has a co-continuous phase-separated structure made of the first phase and the second phase. Therefore, the resin (the second resin) which forms the second phase is incompatible with the resin (the first resin) which forms the first phase. In other words, the second resin is not compatible with the first resin, thereby forming an interface on the boundary between the first phase and the second phase.

As the resin (the second resin) which forms the second phase, for example, a thermosetting resin is used.

Examples of the thermosetting resin include epoxy resin, thermosetting polyimide resin, phenol resin, urea resin, melamine resin, unsaturated polyester resin, diallyl phthalate resin, silicone resin, and thermosetting urethane resin. Of these, epoxy resin is preferable.

The thermosetting resin is a polymer in which a curable precursor is three-dimensionally crosslinked. The curable precursor is made of a component before curing of the thermosetting resin. For example, when the thermosetting resin is an epoxy resin, the curable precursor contains, for example, an epoxy oligomer, a curing agent, and, if necessary, a curing catalyst.

Examples of the epoxy oligomer include aromatic epoxy resins such as bisphenol type epoxy resin (e.g., bisphenol A type epoxy resin, etc.), novolak type epoxy resin, and naphthalene type epoxy resin; ring containing nitrogen epoxy resins such as triepoxypropyl isocyanurate (triglycidyl isocyanurate) and hydantoin epoxy resin; aliphatic epoxy resin, alicyclic epoxy resin (e.g., dicyclo ring type epoxy resin, etc.), glycidyl ether type epoxy resin, and glycidyl amine type epoxy resin. Of these, alicyclic epoxy resin and aromatic epoxy resin are preferable.

As the epoxy oligomer, commercially available products can be used, such as CELLOXIDE 2021P, EHPE-3150CE (hereinabove, manufactured by Daicel Chemical Industries, Ltd.), jER-828, jER-1002, and jER-1010 (hereinabove, manufactured by Japan Epoxy Resin Co., Ltd.).

The epoxy oligomer has a weight average molecular weight of, for example, 100 to 1000, or preferably 200 to 500.

These epoxy oligomers can be used alone or in combination of two or more kinds.

Examples of the curing agent include epoxy resin curing agents such as acid anhydride compound and phenol compound.

Examples of the acid anhydride compound include phthalic anhydride, maleic anhydride, tetrahydrophthalic anhydride, hexahydrophthalic anhydride, and 4-methyl hexahydrophthalic anhydride.

Examples of the phenol compound include polyvinylphenol.

These curing agents can be used alone or in combination of two or more kinds.

The curing agent is blended in a proportion of, for example, 0.8 to 1.2 equivalents, or preferably 0.9 to 1.1 equivalents, to the epoxy oligomer.

Known curing catalysts such as base compounds are used as the curing catalyst. Such curing catalysts include, for example, imidazole compounds, and diazabicyclo compounds.

Examples of the imidazole compound include methylimidazole, 2-ethyl-4-methylimidazole, ethylimidazole, phenylimidazole (e.g., 2-phenylimidazole, etc.), and undecylimidazole.

Examples of the diazabicyclo compound include diazabicycloundecen (DBU).

These curing catalysts can be used alone or in combination of two or more kinds.

The curing catalyst is mixed in a proportion of, for example, 1 to 5 parts by weight, or preferably 2 to 4 parts by weight, to 100 parts by weight of the epoxy oligomer.

The curing temperature of the curable precursor is in the range of, for example, 60 to 200° C., or preferably 70 to 180° C., depending upon the curing agent to be blended as necessary.

In the present invention, the inorganic materials that may be used include, for example, inorganic materials incompatible with a thermoplastic resin and a thermosetting resin. More specifically, examples thereof include carbide, nitride, oxide, metal, carbon material.

Examples of the carbide include silicon carbide, boron carbide, aluminum carbide, titanium carbide, and tungsten carbide.

Examples of the nitride include silicon nitride, boron nitride, aluminum nitride, gallium nitride, chromium nitride, tungsten nitride, magnesium nitride, molybdenum nitride, and lithium nitride.

Examples of the oxide include silicon oxide (silica), aluminum oxide (alumina), magnesium oxide (magnesia), cerium oxide (ceria: e.g., CeO₂, Ce₂O₃, etc.), titanium oxide, and iron oxide. Further examples thereof include indium tin oxide and antimony tin oxide, to which metal ion is doped.

Examples of the metal include copper, gold, nickel, tin, and iron, or alloys thereof.

Examples of the carbon material include carbon black, graphite, diamond, fulleren, carbon nanotube, carbon nanofiber, nanohorn, carbon microcoil, and nanocoil.

Preferably, the surface of the inorganic material is chemically modified. In order to chemically modify the inorganic material, a chemical modifying agent (a surface modifying agent) is allowed to react with the surface of the inorganic material. As such chemical modifying agent, for example, a hydrophobic introducing compound for hydrophobicizing the surface of the inorganic material, or a hydrophilic introducing compound for hydrophilizing the surface of the inorganic material is used.

The hydrophobic introducing compound is a compound having both a hydrophobic group and a functional group which is allowed to react with a hydroxyl group present on the surface of the inorganic material, and examples thereof include carboxylic acid such as hexanoic acid, decanoic acid, and oleic acid; amine such as hexylamine and decylamine; and aminocarboxylic acid such as aminohexanoic acid.

The hydrophilic introducing compound is a compound having both a hydrophilic group and a functional group which is allowed to react with a hydroxyl group present on the surface of the inorganic material, and examples thereof include p-hydroxybenzoic acid, 4-oxo valeric acid, 4-hydroxyphenyl acetic acid, sebacic acid, 5-oxohexanoic acid, 3-(4-hydroxyphenyl)propionic acid, 3-(4-carboxyphenyl)propionic acid, 7-oxooctanoic acid, and 6-hydroxycaproic acid.

The inorganic material and the chemical modifying agent are allowed to react by mixing a salt (nitrate, sulfate, etc.) or hydroxide of the inorganic material with the above-mentioned chemical modifying agent.

Reaction conditions include a reaction temperature of, for example, 380 to 420° C., or preferably 390 to 410° C.; a reaction pressure of, for example, 30 to 50 MPa, or preferably 35 to 45 MPa; and a reaction time of, for example, 5 to 20 minutes, or preferably 10 to 15 minutes. A known hydrothermal synthesis reaction system is used for the above reaction.

Regarding each of the components, the chemical modifying agent is mixed in a proportion of, for example, 10 to 5000 parts by weight, or preferably 200 to 1000 parts by weight, to 100 parts by weight of salts or hydroxide of inorganic particles.

In the case of allowing the inorganic particles to react under conditions of room temperature and normal pressure, the inorganic particles are easily aggregated, making it difficult to chemically modify surfaces of the inorganic particles efficiently. On the other hand, according to such method, the surfaces of the inorganic particles can be chemically modified while these particles are kept fine. Therefore, highly dispersible, fine inorganic particles can be obtained.

Thus, a hydrophobic group or a hydrophilic group can be introduced to impart hydrophobicity or hydrophilicity to the surface of the inorganic material, so that the inorganic material can be reliably localized at an interface.

The inorganic material is appropriately selected according to the application and purpose. For example, when used as a heat-dissipating material, the organic-inorganic composite of the present invention requires heat resistance and thermal conductivity, and further requires dielectric strength, and insulation property if necessary. Therefore, in this case, the inorganic material is selected from, for example, carbide, nitride, oxide, and metal. When the organic-inorganic composite is also used as a heat-dissipating material, the inorganic material has a thermal conductivity of, for example, 10 W/m·K or more, preferably 30 W/m·K or more, and usually 2000 W/m·K or less. In addition, when the organic-inorganic composite also requires insulation property, the inorganic material has a volume resistivity of, for example, 10⁸ Ω·cm or more, preferably 10¹² Ω·cm, and usually 10¹⁶ Ω·cm or less.

When the organic-inorganic composite of the present invention is used as a conductive material, it requires heat resistance and conductivity. Therefore, in this case, the inorganic material is selected from, for example, metal and carbon material. When the organic-inorganic composite is also used as a conductive material, the inorganic material has a volume resistivity of, for example, 10⁻³ Ω·cm or less, preferably 10⁻⁴ Ω·m or less, and usually 10⁻⁷ Ω·cm or less.

The inorganic material is preferably formed in the form of inorganic particles.

The inorganic particles can be obtained as they are in the form of particles made of the above-mentioned inorganic materials or can be obtained by molding the above-mentioned inorganic materials into particles by a known method such as pulverization.

The inorganic particle has an average particle size of, for example, 3 to 5000 nm, or preferably 10 to 500 nm.

Next, a method for manufacturing the organic-inorganic composite of the present invention will be described.

First, in this method, a thermoplastic resin, a curable precursor, an inorganic material, and a solvent are mixed and then sufficiently stirred to prepare a mixed solution.

The solvent is not particularly limited as long as it can dissolve the thermoplastic resin and the curable precursor. Examples thereof include organic solvents such as N-methyl-2-pyrrolidone (hereinafter referred to as NMP), N,N-dimethylacetamide, N,N-dimethylformamide, 1,3-dimethyl-2-imidazolidinone, dimethyl sulfoxide, and methyl ethyl ketone (hereinafter referred to as MEK). These solvents can be used alone or in combination of two or more kinds.

The mixing proportion of each of the components in the mixed solution is as follows. To 100 parts by weight of the thermoplastic resin, the curable precursor is mixed in a proportion of, for example, 50 to 400 parts by weight, or preferably 60 to 350 parts by weight, the inorganic material is mixed in a proportion of, for example, 10 to 2000 parts by weight, or preferably 100 to 500 parts by weight, and the solvent is mixed in a proportion of, for example, 400 to 10000 parts by weight, or preferably 450 to 800 parts by weight. The inorganic particles are mixed in a proportion of, for example, 3 to 100 parts by volume, or preferably 5 to 50 parts by volume, to 100 parts by volume of the total volume of the thermoplastic resin, the curable precursor, and the solvent.

If necessary, a surfactant or an additive such as antioxidant, an ultraviolet absorber, a light stabilizer, pigment, a dye, a mildewproof agent, and a flame retardant is added to the mixed solution.

The surfactant is added in order to control the surface activity of a first phase and a second phase, and examples thereof include an anionic surfactant, a cationic surfactant, an amphoteric surfactant, and a nonionic surfactant.

Examples of the anionic surfactant include carboxylate, alkyl sulfonate, alkyl allyl sulfonate, alkyl sulfate, sulfated oil, and sulfate.

Examples of the cationic surfactant include amine salt, tetraalkyl quaternary ammonium salt, trialkyl benzyl quaternary ammonium salt, alkyl pyridinium salt, and alkyl sulfonium salt.

Examples of the amphoteric surfactant include betaine, sulfobetaine, and sulfate betaine.

Examples of the nonionic surfactant include fatty acid monoglycerol ester, fatty acid polyglycol ester, fatty acid sorbitan ester, fatty acid sucrose ester, fatty acid alkanolamide, fatty acid polyethylene glycol condensate, fatty acid amide polyethylene glycol condensate, alkylphenol polyethylene glycol condensate, and polypropylene glycol polyethylene glycol condensate.

These surfactants can be used alone or in combination of two or more kinds. Of these surfactants, an amphoteric surfactant is preferable.

The surfactant is mixed in a proportion of, for example, 0.1 to 1 part by weight, or preferably 0.15 to 0.8 parts by weight, to 100 parts by weight of the total amount of the thermoplastic resin and the curable precursor.

When the proportion of the surfactant is less than the above range, a co-continuous phase-separated structure may be less likely to be formed. On the other hand, when it exceeds the above range, the second phase of the thermosetting resin may be less likely to form a three-dimensionally continuous structure.

Next, in this method, the mixed solution is heated.

Specifically, the mixed solution is first heated to prepare a composite precursor, and this composite precursor is further heated to obtain an organic-inorganic composite.

More specifically, the mixed solution prepared in the above-mentioned mixing proportions is first heated to a temperature (softening temperature) at which a thermoplastic resin softens or higher, and to a temperature (curing temperature) lower than a temperature at which a curable precursor is cured.

The heating conditions of the mixed solution depend on the purpose and application, and the heating temperature ranges, for example, from 60 to 100° C., or preferably from 70 to 90° C., and the heating time ranges, for example, from 15 to 60 minutes, or preferably from 20 to 40 minutes.

When the heating temperature is less than the above range, the solvent may be less likely to be removed, the thermoplastic resin and the curable precursor may be less compatible with each other, and further, the inorganic particles may be less likely to be dispersed therein. On the other hand, when it exceeds the above range, the curable precursor may be cured.

Thus, the solvent is removed, the thermoplastic resin and the curable precursor are allowed to be compatible with each other, and the inorganic particles are dispersed therein. In this manner, a composite precursor can be obtained.

Next, in this method, the composite precursor thus obtained is further heated to form an organic-inorganic composite.

Specifically, the composite precursor obtained by the above process is heated to a temperature at which the curable precursor is cured or higher.

The heating conditions of the composite precursor include a heating temperature of, for example, 100° C. or higher, or preferably 140° C. or higher, and less than 180° C., or preferably less than 160° C., and a heating time of, for example, 30 to 120 minutes, or preferably 50 to 70 minutes.

When the heating temperature is less than the above range, the curable precursor may not be cured. On the other hand, when it exceeds the above range, the second phase made of the thermosetting resin may be less likely to form a three-dimensionally continuous structure.

Thus, the curable precursor is crosslinked in the three-dimensionally continuous first phase of the thermoplastic resin to form a three-dimensionally continuous second phase of the thermosetting resin, and at the same time, an inorganic material is localized at the interface between the thermoplastic resin and the thermosetting resin.

Thus, the curing of the curable precursor can produce an organic-inorganic composite containing a composite resin having a co-continuous phase-separated structure formed of a three-dimensionally continuous first phase made of thermoplastic resin, and a three-dimensionally continuous second phase made of thermosetting resin; and inorganic particles localized at the interface between the first phase and the second phase.

Specifically, a molded product of the organic-inorganic composite can be obtained as a molded product, for example, in a sheet (coat) or bulk (massive) form.

When the organic-inorganic composite molded product thus obtained is used as a heat-dissipating material, the thermal conductivity thereof ranges, for example, from 0.5 to 50 W/m·K, or preferably from 1 to 30 W/m·K.

When the thermal conductivity thereof is within the above range, the organic-inorganic composite molded product can efficiently dissipate.

When the organic-inorganic composite molded product requires insulation property, the volume resistivity thereof ranges, for example, from 10⁸ to 10¹⁶ Ω·cm, or preferably 10¹² to 10¹⁶ Ω·cm.

When the volume resistivity thereof is within the above range, the organic-inorganic composite molded product can be efficiently insulated.

When the organic-inorganic composite molded product thus obtained is used as a conductive material, the electric conductivity thereof ranges, for example, from 10⁻⁶ to 10⁴ Ω·cm, or preferably 10⁻⁵ to 1 Ω·cm.

When the electric conductivity thereof is within the above range, the organic-inorganic composite molded product can be efficiently conducted.

Since the inorganic material is localized at the interface between the three-dimensionally continuous first phase and the three-dimensionally continuous second phase, the organic-inorganic composite thus obtained has a three-dimensionally continuous inorganic material path formed. Therefore, such path allows heat or electricity to pass through, thereby achieving effective heat dissipation or electric conduction. Since the inorganic material is localized at the interface between the three-dimensionally continuous first phase and the three-dimensionally continuous second phase, even a small proportion of the inorganic material to the composite resin allows heat dissipation or conductivity of the inorganic material to be effectively exhibited.

As a result, the organic-inorganic composite can be suitably used as a heat-dissipating material or a conductive material, while an increase in cost or deterioration in mechanical strength can be prevented.

### EXAMPLES

While in the following, the present invention is described in further detail with reference to Example and Comparative Example, the present invention is not limited to any of them.

In Examples and Comparative Examples, the thermal conductivity was measured as follows.

That is, a laser flash method thermal constant measuring system (TC-9000, manufactured by ULVAC-RIKO Inc.) was used for measurement of thermal conductivity.

The thermal conductivity λ was calculated from the following formula with density P, specific heat capacity c, and thermal diffusivity a of a test sample.

λ=P×c×a

The density P was obtained from the weight and the shape dimension of the test sample.

The specific heat capacity c was obtained from output of a pulsed laser irradiated for heating the test sample and from temperature rise of the test sample at that time, using the above-mentioned system.

The thermal diffusivity a is obtained by analyzing the temperature response of the back side of the test sample heated with the pulsed laser by a halftime method.

In Examples and Comparative Examples, the volume resistivity was measured using a resistivity meter (MCP-T610 type and MCP-HT450 type, manufactured by Mitsubishi Chemical Analytech Co., Ltd.).

### Preparation of Chemically Modified Inorganic Particles

### Preparation Example 1

A mixed solution of 2600 μL (0.02 mol/L) of aqueous solution of cerium hydroxide and 53.7 mg of decanoic acid was supplied into a batch type high-pressure reactor, and was allowed to react at 400° C. under 40 MPa for 10 minutes. Subsequently, the reactor was rapidly cooled, and the mixed solution was washed by centrifugal separation to remove unreacted decanoic acid, so that cerium oxide particles of which surfaces were chemically modified with decanoic acid were obtained.

### Preparation Example 2

The same procedures as in Preparation Example 1 were carried out except that 53.7 mg of decanoic acid was replaced with 88.1 mg of oleic acid in Preparation Example 1, so that cerium oxide particles of which surfaces were chemically modified with oleic acid were obtained.

### Preparation Example 3

The same procedures as in Preparation Example 1 were carried out except that 53.7 mg of decanoic acid was replaced with 146.9 mg of oleic acid in Preparation Example 1, so that cerium oxide particles of which surfaces were chemically modified with oleic acid were obtained.

### Preparation Example 4

A mixed solution of 189 μL of water, 43 mg of copper formate, 359.7 μL of formic acid, and 32.6 mg of decanoic acid was supplied into a batch type high-pressure reactor, and was allowed to react at 400° C. under 10 MPa for 10 minutes. Subsequently, the reactor was rapidly cooled, and the mixed solution was washed by centrifugal separation with each of water and ethanol to remove unreacted decanoic acid, so that copper particles of which surfaces were chemically modified with decanoic acid were obtained.

### Preparation Example 5

A mixed solution of 1297 μL of water, 455.9 mg of copper formate, 135.9 μL of formic acid, and 307.7 mg of decanoic acid was supplied into a batch type high-pressure reactor, and was allowed to react at 400° C. under 30 MPa for 10 minutes. Subsequently, the reactor was rapidly cooled, and the mixed solution was washed by centrifugal separation with each of water and ethanol to remove unreacted decanoic acid, so that copper particles of which surfaces were chemically modified with decanoic acid were obtained.

### Example 1

Blended with 5 g of 20% by weight NMP solution of Ultem 1000 (polyetherimide resin, manufactured by GE Plastics Japan Ltd.) were 2 g of CELLOXIDE 2021P (alicyclic epoxy resin, manufactured by Daicel Chemical Industries, Ltd.), 1.29 g of RIKACID MH700 (epoxy resin curing agent, a mixture of 4-methylhexahydrophthalic anhydride and hexahydrophthalic anhydride (at a weight ratio of 70/30), manufactured by New Japan Chemical Co., Ltd.), and 1.37 g of 5% by weight NMP solution of Curezol 2PZ (epoxy resin curing agent, 2-phenylimidazole, manufactured by Shikoku Chemicals Corporation). The mixture was stirred to be uniform to thereby obtain a clear mixed solution.

Subsequently, 1 g of 1% by weight NMP solution of NIKKOL AM-301 (amphoteric surfactant, aqueous solution of lauryldimethyl betaine aminoacetate, manufactured by Nikko Chemicals Co., Ltd.) was blended with this mixed solution, and the mixture was sufficiently stirred with a hybrid mixer.

Then, the inorganic particles of Preparation Example 1 were blended with the mixed solution so that the proportion thereof was 10% by volume to the mixed solution before blending.

Next, this mixed solution was applied onto a soda glass using a spin coater so that the coating thickness after drying was 100 μM. The coated solution was then heated at 80° C. for 30 minutes to prepare a composite precursor, and was subsequently heated at 150° C. for 60 minutes to obtain a sheet of an organic-inorganic composite.

The sheet thus obtained had a thermal conductivity of 0.7 W/m·K. Such sheet was excellent in mechanical strength.

### Example 2

Blended with 3.23 g of 20% by weight MEK (methyl ethyl ketone) solution of polymethyl methacrylate resin (manufactured by Wako Pure Chemical Industries, Ltd.), 1 g of jER (bisphenol A type epoxy resin, manufactured by Japan Epoxy Resins Co., Ltd.), 0.85 g of RIKACID MI-1700 (epoxy resin curing agent, a mixture of 4-methylhexahydrophthalic anhydride and hexahydrophthalic anhydride (at a weight ratio of 70/30), manufactured by New Japan Chemical Co., Ltd.), and 0.37 g of 5% by weight MEK solution of Curezol 2PZ (epoxy resin curing agent, 2-phenylimidazole, manufactured by Shikoku Chemicals Corporation). The mixture was sufficiently stirred to be uniform using a hybrid mixer, to thereby obtain a clear mixed solution.

Then, the inorganic particles of Preparation Example 1 were blended with the mixed solution so that the proportion thereof was 10% by volume to the mixed solution before blending.

Next, this mixed solution was applied onto a soda glass using a spin coater (500 min⁻¹) so that the coating thickness after drying was 100 μm. The coated solution was then heated at 80° C. for 30 minutes to prepare a composite precursor, and was subsequently heated at 150° C. for 60 minutes to obtain a sheet of an organic-inorganic composite.

The sheet thus obtained had a thermal conductivity of 1.3 W/m·K. Such sheet was excellent in mechanical strength.

### Example 3

Blended with 5 g of 20% by weight NMP solution of Ultem 1000 (polyetherimide resin, manufactured by GE Plastics Japan Ltd.) were 2 g of CELLOXIDE 2021P (alicyclic epoxy resin, manufactured by Daicel Chemical Industries, Ltd.), 1.29 g of RIKACID MH700 (epoxy resin curing agent, a mixture of 4-methylhexahydrophthalic anhydride and hexahydrophthalic anhydride (at a weight ratio of 70/30), manufactured by New Japan Chemical Co., Ltd.), and 1.37 g of 5% by weight NMP solution of Curezol 2PZ (epoxy resin curing agent, 2-phenylimidazole, manufactured by Shikoku Chemicals Corporation). The mixture was stirred to be uniform to thereby obtain a clear mixed solution.

Subsequently, 1 g of 1% by weight NMP solution of NIKKOL AM-301 (amphoteric surfactant, aqueous solution of lauryldimethyl betaine aminoacetate, manufactured by Nikko Chemicals Co., Ltd.) was blended with this mixed solution, and the mixture was sufficiently stirred with a hybrid mixer.

Then, the inorganic particles of Preparation Example 4 were blended with the mixed solution so that the proportion thereof was 10% by volume to the mixed solution before blending.

Next, this mixed solution was applied onto a soda glass using a spin coater so that the coating thickness after drying was 100 μm. The coated solution was then heated at 80° C. for 30 minutes to prepare a composite precursor, and was subsequently heated at 150° C. for 60 minutes to obtain a sheet of an organic-inorganic composite.

The sheet thus obtained had a volume resistivity of 10⁻² Ω·cm and exhibited conductivity. Such sheet was excellent in mechanical strength.

### Example 4

Blended with 3.23 g of 20% by weight MEK (methyl ethyl ketone) solution of polymethyl methacrylate resin (manufactured by Wako Pure Chemical Industries, Ltd.), 1 g of jER (bisphenol A type epoxy resin, manufactured by Japan Epoxy Resins Co., Ltd.), 0.85 g of RIKACID MH700 (epoxy resin curing agent, a mixture of 4-methylhexahydrophthalic anhydride and hexahydrophthalic anhydride (at a weight ratio of 70/30), manufactured by New Japan Chemical Co., Ltd.), and 0.37 g of 5% by weight MEK solution of Curezol 2PZ (epoxy resin curing agent, 2-phenylimidazole, manufactured by Shikoku Chemicals Corporation). The mixture was sufficiently stirred to be uniform using a hybrid mixer, to thereby obtain a clear mixed solution.

Then, the inorganic particles of Preparation Example 5 were blended with the mixed solution so that the proportion thereof was 10% by volume to the mixed solution before blending.

Next, this mixed solution was applied onto a soda glass using a spin coater (500 min⁻¹) so that the coating thickness after drying was 100 μm. The coated solution was then heated at 80° C. for 30 minutes to prepare a composite precursor, and was subsequently heated at 150° C. for 60 minutes to obtain a sheet of an organic-inorganic composite.

The sheet thus obtained had a volume resistivity of 10⁻² Ω·cm and exhibited conductivity. Such sheet was excellent in mechanical strength.

### Comparative Example 1

To 5 g of MEK (methyl ethyl ketone) were added 2.00 g of jER 828 (epoxy resin, manufactured by Japan Epoxy Resins Co., Ltd.), 55 g of NC3000H (epoxy resin, manufactured by Nippon Kayaku Co., Ltd.), 1.7 g of RIKACID MH700 (epoxy resin curing agent, a mixture of 4-methylhexahydrophthalic anhydride and hexahydrophthalic anhydride (at a weight ratio of 70/30), manufactured by New Japan Chemical Co., Ltd.), and 0.74 g of 5% by weight MEK solution of Curezol 2PZ (epoxy resin curing agent, 2-phenylimidazole, manufactured by Shikoku Chemicals Corporation). The mixture was sufficiently stirred to be uniform using a hybrid mixer, to thereby obtain a clear mixed solution.

Then, the inorganic particles of Preparation Example 1 were blended with the mixed solution so that the proportion thereof was 10% by volume to the mixed solution before blending.

Next, this mixed solution was applied onto a soda glass using a spin coater so that the coating thickness after drying was 100 μm. The coated solution was then heated at 80° C. for 30 minutes to prepare a composite precursor, and was subsequently heated at 150° C. for 60 minutes to obtain a sheet of an organic-inorganic composite.

The sheet thus obtained had a thermal conductivity of 0.3 W/m·K. Such sheet was excellent in mechanical strength.

### Comparative Example 2

To 5 g of MEK (methyl ethyl ketone) were added 2.00 g of jER 828 (epoxy resin, manufactured by Japan Epoxy Resins Co., Ltd.), 1.7 g of RIKACID MH700 (epoxy resin curing agent, a mixture of 4-methylhexahydrophthalic anhydride and hexahydrophthalic anhydride (at a weight ratio of 70/30), manufactured by New Japan Chemical Co., Ltd.), and 0.74 g of 5% by weight MEK solution of Curezol 2PZ (epoxy resin curing agent, 2-phenylimidazole, manufactured by Shikoku Chemicals Corporation). The mixture was sufficiently stirred to be uniform using a hybrid mixer, to thereby obtain a clear mixed solution.

Then, the inorganic particles of Preparation Example 1 were blended with the mixed solution so that the proportion thereof was 30% by volume to the mixed solution before blending.

Next, this mixed solution was applied onto a soda glass using a spin coater so that the coating thickness after drying was 100 μm. The coated solution was then heated at 80° C. for 30 minutes to prepare a composite precursor, and was subsequently heated at 150° C. for 60 minutes to obtain a sheet of an organic-inorganic composite.

The sheet thus obtained had a thermal conductivity of 0.6 W/m·K. However, such sheet was weak in mechanical strength and brittle.

### Comparative Example 3

To 5 g of MEK (methyl ethyl ketone) were added 2.00 g of jER 828 (epoxy resin, manufactured by Japan Epoxy Resins Co., Ltd.), 55 g of NC3000H (epoxy resin, manufactured by Nippon Kayaku Co., Ltd.), 1.7 g of RIKACID MH700 (epoxy resin curing agent, a mixture of 4-methylhexahydrophthalic anhydride and hexahydrophthalic anhydride (at a weight ratio of 70/30), manufactured by New Japan Chemical Co., Ltd.), and 0.74 g of 5% by weight MEK solution of Curezol 2PZ (epoxy resin curing agent, 2-phenylimidazole, manufactured by Shikoku Chemicals Corporation). The mixture was sufficiently stirred to be uniform using a hybrid mixer, to thereby obtain a clear mixed solution.

Then, the inorganic particles of Preparation Example 4 were blended with the mixed solution so that the proportion thereof was 10% by volume to the mixed solution before blending.

Next, this mixed solution was applied onto a soda glass using a spin coater so that the coating thickness after drying was 100 μm. The coated solution was then heated at 80° C. for 30 minutes to prepare a composite precursor, and was subsequently heated at 150° C. for 60 minutes to obtain a sheet of an organic-inorganic composite.

The sheet thus obtained had a volume resistivity of 10¹³ Ω·cm and exhibited insulation property. Such sheet was excellent in mechanical strength.

### Comparative Example 4

To 5 g of MEK (methyl ethyl ketone) were added 2.00 g of jER 828 (epoxy resin, manufactured by Japan Epoxy Resins Co., Ltd.), 1.7 g of RIKACID MH700 (epoxy resin curing agent, a mixture of 4-methylhexahydrophthalic anhydride and hexahydrophthalic anhydride (at a weight ratio of 70/30), manufactured by New Japan Chemical Co., Ltd.), and 0.74 g of 5% by weight MEK solution of Curezol 2PZ (epoxy resin curing agent, 2-phenylimidazole, manufactured by Shikoku Chemicals Corporation). The mixture was sufficiently stirred to be uniform using a hybrid mixer, to thereby obtain a clear mixed solution.

Then, the inorganic particles of Preparation Example 5 were blended with the mixed solution so that the proportion thereof was 30% by volume to the mixed solution before blending.

Next, this mixed solution was applied onto a soda glass using a spin coater so that the coating thickness after drying was 100 μm. The coated solution was then heated at 80° C. for 30 minutes to prepare a composite precursor, and was subsequently heated at 150° C. for 60 minutes to obtain a sheet of an organic-inorganic composite.

The sheet thus obtained had a volume resistivity of 10⁻¹Ω·cm and exhibited conductivity. However, such sheet was weak in mechanical strength and brittle.

(Evaluation)

The cross section of the sheet thus obtained in each of Examples and Comparative Examples was observed under SEM.

In Examples 1 and 3, it was confirmed that the inorganic particles were localized at the interface between the three-dimensionally continuous first phase made of polyetherimide resin and the three-dimensionally continuous second phase of made epoxy resin.

In Examples 2 and 4, it was confirmed that the inorganic particles were localized at the interface between the three-dimensionally continuous first phase made of polymethyl methacrylate resin and the three-dimensionally continuous second phase made of epoxy resin.

On the other hand, in Comparative Examples 1 to 4, it was confirmed that the inorganic particles were discontinuously and uniformly dispersed in the epoxy resin.

### Reference Examples 1 and 2

(Localization of Inorganic Particles Having Chemically Modified Surface at Two-Phase Interface)

In the present invention, Reference Examples to be referred to in regard to the principle that inorganic particles are localized at the interface between the first phase and the second phase are shown. After the inorganic particles were supplied in an organic solvent and an aqueous two-phase liquid, such Reference Examples confirmed existing location of the inorganic particles in the two-phase liquid.

Specifically, each of the organic solvents (hexane, decane, toluene, chloroform, dichloromethane, decanol, and ethyl acetate) described in Table 1 and water were first supplied into a vessel, to prepare a two-phase liquid made of an organic solvent and water. Subsequently, the inorganic particles of Preparation Examples 2 and 3 were supplied to each of these two-phase liquids. Thereafter, each liquid was irradiated with a laser pointer light, and the Tyndall effect exhibited in any of the organic solvent, water, and the interface therebetween was observed. This confirmed existing location of the inorganic particles.

As inorganic particles, Reference Example 1 used inorganic particles in Preparation Example 2, and Reference Example 2 used inorganic particles in Preparation Example 3.

The results of Reference Examples 1 and 2 are shown together with solubility parameters (SP value) of the organic solvents in Table 1.

The symbols in Table 1 are shown below.

A: The existence of the inorganic particles was observed.

B: The existence of the inorganic particles was slightly observed.

C: The existence of the inorganic particles was not able to be observed.

TABLE 1

| | | Organic Solvent | | | | | | |
|---|---|---|---|---|---|---|---|---|
| | | | | | Methyl | | Dichloro- | |
| | | Hexane | Decane | Toluene | Acetate | Chloroform | methane | Decanol |
| | | SP Value of Organic Solvent | | | | | | |
| | | 7.3 | 7.8 | 8.9 | 9.0 | 9.2 | 9.8 | 11.5 |
| Reference | Organic | A | A | A | C | A | A | A (cloudy) |
| Example 1 | Solvent | | | | | | | |
| | Interface | C | B | C | A | A | A | A |
| | Water | C | C | C | C | C | C | C |
| Reference | Organic | C | B | B | C | B | B | A |
| Example 2 | Solvent | | | | | | | |
| | Interface | A | A | A | A | A | A | A |
| | Water | C | C | C | C | C | C | B |

Table 1 shows that in Reference Example 1, in the two-phase liquid using methyl acetate having an SP value of 9.0 as the organic solvent, the inorganic particles were not found to be present, and the inorganic particles were localized at the interface between the organic solvent and water.

On the other hand, in Reference Example 1, in the two-phase liquid using each of hexane, decane, and toluene whose SP values were lower than 9.0, as organic solvents, the inorganic particles were found to be present in the organic solvents.

In Reference Example 1, in the two-phase liquid using each of chloroform, dichloromethane, and decanol whose SP values were higher than 9.0 as the organic solvent, the inorganic particles were found to be present in both the interface between each of the organic solvents and water and in the organic solvents.

In Reference Example 2, in the two-phase liquid using each of hexane having an SP value of 7.3 and methyl acetate having an SP value of 9.0 as the organic solvent, the inorganic particles were not found to be present in the organic solvents and in water, and the inorganic particles were localized at the interface between each of the organic solvents and water.

On the other hand, in Reference Example 2, in the two-phase liquid using each of decane having an SP value of 7.8, toluene having an SP value of 8.9, chloroform having an SP value of 9.2, and dichloromethane having an SP value of 9.8 as the organic solvent, the inorganic particles were found to be present both at the interface between the organic solvent and water and in the organic solvent.

In Reference Example 2, in the two-phase liquid using decanol having an SP value of 11.5 as the organic solvent, the inorganic particles were found to be present any of at the interface between the organic solvent and water, in the organic solvent, and in water.

As seen above, the solubility parameter of the organic solvent and the chemical modification of the surface of the inorganic particle are appropriately selected, so that the inorganic particles can be separated from both the organic solvent and water (to be incompatible), allowing to be localized at the interface between these two-phase liquids.

Therefore, it is deduced that since these Reference Examples adopt the principle that the inorganic particles are applied to a two-phase liquid, the inorganic particles can be applied to a composite resin having a co-continuous phase-separated structure.

While the illustrative embodiments of the present invention are provided in the above description, such is for illustrative purpose only and it is not to be construed restrictively. Modification and variation of the present invention that will be obvious to those skilled in the art is to be covered by the following claims.

### INDUSTRIAL APPLICABILITY

The organic-inorganic composite of the present invention is suitably used as a heat-dissipating material or a conductive material.

1. An organic-inorganic composite comprising:
a composite resin having a co-continuous phase-separated structure formed of a three-dimensionally continuous first phase made of a first resin and a three-dimensionally continuous second phase made of a second resin which is different from the first resin; and
an inorganic material localized at an interface between the first phase and the second phase.

2. The organic-inorganic composite according to claim 1, wherein a surface of the inorganic material is chemically modified.

3. The organic-inorganic composite according to claim 1, wherein
the first resin is a thermoplastic resin, and
the second resin is a thermosetting resin.

4. The organic-inorganic composite according to claim 3, wherein
the thermoplastic resin is a polyimide resin or an acrylic resin, and
the thermosetting resin is an epoxy resin.

5. A method for manufacturing an organic-inorganic composite, comprising the steps of:
blending a first resin, a curable precursor of a second resin which is different from the first resin, an inorganic material, and a solvent to prepare a mixed solution; and
removing the solvent by heating the mixed solution and curing the curable precursor, to obtain an organic-inorganic composite containing a composite resin having a co-continuous phase-separated structure formed of a three-dimensionally continuous first phase made of the first resin and a three-dimensionally continuous second phase made of the second resin, and the inorganic material localized at an interface between the first phase and the second phase.

6. The method for manufacturing the organic-inorganic composite according to claim 5, wherein
the first resin is a thermoplastic resin,
the second resin is a thermosetting resin incompatible with the thermoplastic resin, and
the inorganic material is incompatible with the thermoplastic resin and the thermosetting resin,
wherein the step of obtaining the organic-inorganic composite comprises the steps of
removing the solvent by heating the mixed solution to a temperature at which the thermoplastic resin softens or higher and to a temperature lower than a temperature at which the curable precursor is cured, so that a composite precursor in which the thermoplastic resin and the curable precursor are compatible with each other and the inorganic material is dispersed therein is prepared; and
crosslinking the curable precursor in the three-dimensionally continuous first phase of the thermoplastic resin by heating the composite precursor to a temperature at which the curable precursor is cured or higher, to form a three-dimensionally continuous second phase of the thermosetting resin, and at the same time, localizing the inorganic material at an interface between the thermoplastic resin and the thermosetting resin.

7. The method for manufacturing the organic-inorganic composite according to claim 5,
wherein a surfactant is further blended in the step of preparing the mixed solution.
